(19) United States
(12) Patent Application Publication
(10) Pub. No.: US 2019/0318565 A1
(43) Pub. Date: Oct. 17, 2019

(54) COIN LIFT

(71) Applicant: NOVOMATIC AG, Gumpoldskirchen (AT)

(72) Inventors: Thomas ATZINGER, Gumpoldskirchen (AT); Marek GAWEL, Gumpoldskirchen (AT)

(21) Appl. No.: 16/472,253

(22) PCT Filed: Dec. 23, 2016
(86) PCT No.: PCT/IB2016/057990

§ 371 Date: Jun. 21, 2019

(51) Int. Cl. G07D 9/00

(52) U.S. Cl. CPC G07D 9/008

(57) ABSTRACT

The present invention relates to a coin lift for transporting coins and/or coin-like objects. The proposed coin lift has an endless conveyor loop for transporting coins and/or coin-like objects from a first position to a second position higher than the first position, wherein the conveyor loop extends in an ascending direction in a first section and in a descending direction in a second section. Due to a common arrangement of the first and second sections in a housing portion exchangeably arranged between two further housing portions, the coin lift has a compact design and is easily adaptable in its overall height and thus in the height difference which the coins and/or coin-like objects can overcome. At the same time, a reliable transport of the coins and/or coin-like objects is ensured, in particular also with a vertically ascending course of the conveyor loop in the first section, by the arrangement of a press-on element for pressing the coins and/or coin-like objects transported by the conveyor loop onto the conveyor loop.

### FIELD OF INVENTION

The present invention relates to a coin lift for transporting coins and/or coin-like objects and, in particular, a coin lift with a modular design for transporting coins and/or coin-like objects in a steep ascending direction.

### BACKGROUND

Coin lifts are typically used in money-operated equipment such as vending machines, ticket vending machines, amusement machines, etc. The operation of these money-operated devices involves the input of money, often in the form of coins, into a coin slot. These coins, after having been inserted into the device, are then forwarded by means of a coin channel on the payment side to a cash out and/or coin payment unit—a so-called hopper—in which the coins are available in a sorted form. If a coin is to be disbursed from the device, it is usually transferred from the hopper to a coin channel on the disbursement side by means of a coin lift and finally to a coin payout tray. Among other things, the coin lift serves to overcome a difference in height between a coin collecting container of the hopper and the coin payout tray.

State of the art coin lifts usually have an endless conveyor loop which picks up the coins, either by utilizing the static friction that occurs between the coins and a surface of the conveyor loop or by using lips on the surface of the conveyor loop that are attached approximately transversely to the direction of transport, and transports them in an upward direction. However, the static friction is often not sufficient to transport the coins reliably in a vertical ascending direction. This is particularly problematic in the case of used coins, which may have even lower static friction values than new coins, due to contamination. Even when using lips attached to the surface of the conveyor loop approximately transversely to the transport direction, vertical transport of the coins can cause coins to slip off the lips and fall downwards. In order to avoid the problem of too little static friction or slippage of the coins, either the entire conveyor loop or at least the part for the upward transport of the coins is usually arranged in an orientation inclined towards the vertical direction. However, the disadvantage of this is that the conveyor loop takes up a larger construction volume to overcome a given height difference than in a vertical arrangement. The space available in the coin-operated machines is typically very limited, so that the design of the coin lift should be as compact as possible.

Furthermore, state-of-the-art coin lifts are not simply adaptable to different heights. These often have a conveyor belt serving as a conveyor loop, which must be entirely replaced in order to adjust the height difference the coins have to overcome, and/or the drive mechanism for the conveyor loop as well as the housing can only be adapted to different heights with great effort.

### SUMMARY OF THE INVENTION

The present invention has therefore the objective of providing a coin lift of the type referred to above, which avoids the disadvantages of the state of the art and provides an advantageous further development of the latter. In particular, a coin lift is to be provided that is designed in a space-saving manner and that can reliably transport used and possibly dirty coins. In addition, the coin lift is to be low-maintenance and its overall height easily adjustable.

In the context of this invention, the term “coin” does not only mean money coins, but also tokens, medals or other coin-like objects.

According to the invention, the task is solved by a coin lift of the type mentioned above with the characteristics of the independent claim. Advantageous embodiments of the present invention are described in the dependent claims.

The inventive solution to the problem is provided by a coin lift of the type mentioned above, which has an endless conveyor loop for transporting coins and/or coin-like objects from a first position to a second position higher than the first position, wherein the conveyor loop extends in an ascending direction in a first section and in a descending direction in a second section. In the second position, the coins and/or coin-like objects have a greater potential energy than in the first position and a transport of the coins and/or coin-like objects in the ascending direction causes an increase in the potential energy of the coins and/or coin-like objects, while in this sense the descending direction is opposite to the ascending direction, i.e. would lead to a reduction in the potential energy.

In preferred embodiments of an inventive coin lift, the first section and the second section of the conveyor loop extend in a straight line and parallel to each other, wherein the first and the second section of the conveyor loop can be arranged closely side by side, and, in particularly preferred embodiments, the conveyor loop extends in a vertically ascending direction in the first section and in a vertically descending direction in the second section, which allows for a particularly space-saving construction of an inventive coin lift.

The conveyor loop extends in a third section from the descending direction of the second section to the ascending direction of the first section and in a fourth section from the ascending direction of the first section to the descending direction of the second section. This means that outside the first and second sections, in which the conveyor loop preferably extends in a straight line and particularly preferably in a vertical ascending or descending direction, the conveyor loop in the third and fourth sections has predominantly curved areas. Thus, for example, the conveyor loop can run in the form of a semi-circular arc throughout the third and fourth sections. As will be seen from the description of the examples below, the third and fourth sections of the conveyor loop preferably occupy a circular arc area extending beyond that of a semicircle, so that the first and second sections of the conveyor loop can be arranged closer together, reducing the volume occupied by a coin lift according to the invention.

Furthermore, a coin lift according to the invention has a drive for selective driving of the conveyor loop in a rotary motion. Advantageously, the drive is arranged such that the conveyor loop is driven by the drive in the third section or the fourth section, but not in the first and second sections. Thus, the first and second sections of the conveyor loop run outside the drive and are therefore easily accessible for adjusting the overall height of a coin lift according to the invention.

Furthermore, a coin lift according to the invention has a press-on element for pressing the coins and/or coin-like objects transported by the conveyor loop onto the conveyor loop. It is preferred that the press-on element substantially remains at its place of installation in the direction of the rotary movement of the conveyor loop and that the coins and/or coin-like objects are guided past the press-on element by the conveyor loop. Alternatively, the press-on element can also move with the conveyor loop in a section of the conveyor loop, so that there is no relative movement between the conveyor loop and the press-on element in the direction of the rotary movement of the conveyor loop. For this purpose, the press-on element can be formed, for example, from a plurality of interconnected articulated segments which, similar to a chain, circulate on a path which, at least in said section, extends substantially along the conveyor loop.

The inventive use of a press-on element has the advantage over the course of the conveyor loop in a simple duct, which is known from the state of the art, that even coins and/or coin-like objects of very different thicknesses can be reliably transported with the conveyor loop. A duct would have to be dimensioned in such a way that the thickest coin and/or the thickest coin-like object could be transported through it on the conveyor loop. However, in the case of coins and/or coin-like objects of very different thicknesses, this may result in the thinnest coins and/or coin-like objects having so much space in the duct that they can become wedged in it. Furthermore, when lips are used on the surface of the conveyor loop as the contact edges for the coins and/or coin-like objects during their transport on the conveyor loop, the height of the lips perpendicular to the surface of the conveyor loop must be less than the combined thickness of two thinnest coins and/or coin-like objects lying one on top of the other, as otherwise the upper coin or the upper coin-like object cannot slip from the underlying coin or coin-like object and there will be no separation of the coins and/or coin-like objects. If, however, very thick coins and/or coin-like objects can also occur, which are considerably thicker than the height of the lips perpendicular to the surface of the conveyor loop, and the duct has to be dimensioned having a correspondingly wide dimension, the thin coins and/or coin-like objects can slip off the lips and fall downwards between the lips and the inner wall of the duct and/or get stuck in the duct.

Preferably, the press-on element extends substantially along the first section of the conveyor loop, as this is where slippage of the coins and/or coin-like objects is most likely to occur due to the preferred vertically ascending course of the conveyor loop. The press-on element can also extend into sections of the conveyor loop adjacent to the first section. This is particularly useful if the coins and/or coin-like objects already show a tendency to slip when the course of the conveyor loop is still inclined, i.e. not yet vertical. For the press-on element to extend into sections of the conveyor loop adjacent to the first section is also useful in order to facilitate the insertion of coins and/or coin-like objects between the press-on element and the conveyor loop. For this purpose, the press-on element should preferably have curved and/or rounded ends or, in the alternative case described above, a corresponding path of the chain link-like segments.

It is also advantageous if the press-on element along the conveyor loop, i.e. in the direction of the course of the conveyor loop and thus in the longitudinal direction of the press-on element, can assume different distances from the conveyor loop in a direction perpendicular to the conveyor loop, i.e. to the surface of the conveyor loop, since successive coins and/or coin-like objects on the conveyor loop, which differ substantially in their thickness, can then be reliably pressed onto the conveyor loop. Otherwise it may occur that the press-on element is held away from the conveyor loop by a thick coin or a thick coin-like object to such an extent that an immediately following or preceding thinner coin or an immediately following or preceding thinner coin-like object is pressed insufficiently or no longer at all by the press-on element onto the conveyor loop and the thinner coin or the thinner coin-like object slips off. This variability in the distance between the press-on element and the conveyor loop, which variability is advantageous in the longitudinal direction of the press-on element, can be achieved, for example, by the press-on element being formed from an elastic plastic and/or the press-on element having, in its longitudinal direction, a plurality of adjacent segments which can be moved substantially independently of one another in a direction perpendicular to the surface of the conveyor loop. This means that the segments can have different distances perpendicular to the surface of the conveyor loop. A further possibility for achieving variability of the distance between the press-on element and the conveyor loop along the conveyor loop, in particular of the distance perpendicular from the pressing-on element to the surface of the conveyor loop, consists in movably supporting a press-on element, which is flexible to a limited extent in its longitudinal direction but is otherwise rigid, at one or more bearing points, which are arranged at a distance from one another in the longitudinal direction of the press-on element, for example by using spring elements. Due to the resulting combination of slight bending of the press-on element and different deflections at the individual bearing points, the press-on element can also be positioned variably along its longitudinal axis with regard to its vertical distance to the surface of the conveyor loop. To achieve this advantageous variability of the distance between the press-on element and the conveyor loop along the conveyor loop, it may also be sufficient to form the press-on element substantially rigid and to mount the press-on element at one or more bearing points movable against the action of one or more spring elements, in particular in a direction perpendicular to the surface of the conveyor loop.

If lips are used on the surface of the conveyor loop as support edges for the coins and/or coin-like objects during their transport on the conveyor loop, it is advantageous if a groove or the like extends through the lips along the conveyor loop, so that a crest or web of the press-on element can pass through the groove and thus through the lips, wherein the press-on element can also safely press coins and/or coin-like objects onto the conveyor loop, the thickness of which is smaller than the height of the lips perpendicular to the surface of the conveyor loop. Otherwise, the lip may keep the press-on element away from a narrower coin or coin-like object, so that the press-on element cannot press the coin or coin-like object flat against the surface of the conveyor loop and the coin or coin-like object may, for example, jam between the conveyor loop and the press-on element.

Preferred embodiments of an inventive coin lift also have a device for dissipating an electrostatic charge from the coins and/or coin-like objects. This is because the friction that occurs between the coins and/or coin-like objects transported by the conveyor loop on the one hand and the press-on element and/or the housing portions on the other hand can lead to electrostatic charging of the coins and/or coin-like objects, which can result in a malfunction or even damage of components in the coin lift itself, but also in the coin-operated device in which the coin lift is installed. Advantageous embodiments of such a device for dissipating an electrostatic charge comprise one or more grounded metal plates over which the coins and/or coin-like objects are guided at one or more positions along their path through the coin lift.

Other preferred embodiments of an inventive coin lift also have a housing comprising a replaceable first housing portion, in which the first portion and the second portion of the conveyor loop run substantially side by side.

Preferably, the housing further has a second housing portion and a third housing portion, wherein the third portion of the conveyor loop extends in the second housing portion and the fourth portion of the conveyor loop extends in the third housing portion.

It is advantageous that the first housing portion connects the second housing portion separably or inseparably with the third housing portion, so that by using first housing portions of different lengths, the overall height of a coin lift according to the invention can be varied.

In preferred embodiments of a coin lift according to the invention, the conveyor loop is formed from a plurality of articulated, separably connected segments. This allows the length of the conveyor loop to be adapted to different overall heights of a coin lift according to the invention by inserting or removing one or more segments without having to replace the entire conveyor loop.

Due to the modular design of a coin lift according to the invention, namely the common arrangement of a first section of a conveyor loop for an ascending, preferably vertically ascending transport of coins and/or coin-like objects and a second section for the return of the conveyor loop in a preferably vertically descending direction in a first housing portion exchangeably arranged between two further housing portions, a coin lift according to the invention has a compact design and is easily adaptable in its overall height and thus in the height difference which the coins and/or coin-like objects can overcome. This adaptability of the overall height is further increased if the conveyor loop is formed from a large number of articulated, separably connected segments in preferred embodiments of a coin lift according to the invention. Thereby, a coin lift according to the invention ensures a reliable transport of the coins and/or coin-like objects in the first section even in case of a vertically ascending conveyor loop, by preventing a slipping of the coins and/or coin-like objects from the conveyor loop by the arrangement of a press-on element according to the invention for pressing the coins and/or coin-like objects transported by the conveyor loop onto the conveyor loop. Even if a coin lift according to the invention is installed in a coin-operated device in such a way that the first section of the conveyor loop is inclined with respect to the vertical direction, so that the coins and/or coin-like objects would fall from the conveyor loop without the press-on element according to the invention, the coin lift according to the invention can still be reliably operated. In addition, even when installed obliquely in a coin-operated device, a coin lift according to the invention still saves space in the coin-operated device by its inventive arrangement of the second section of the conveyor loop immediately adjacent to the first section of the conveyor loop in a common first housing portion that closely encloses the first and second sections of the conveyor loop.

One skilled in the art will appreciate that the above characteristics, which are explained below, can be used not only in the respectively indicated combination, but also in other combinations. The scope of the invention is only defined by the claims.

### BRIEF DESCRIPTION OF FIGURES

The invention will be explained in more detail below using preferred example embodiments and associated drawings. The drawings show:

FIG. 1: a perspective view of an example embodiment of the coin lift according to the invention,

FIG. 2: a side view of the example embodiment according to FIG. 1,

FIG. 3a: a front view of the example embodiment according to FIG. 1,

FIG. 3b: a side view of the section plane A-A through the example embodiment according to FIG. 3a,

FIG. 4a: a front view of another example embodiment of a coin lift according to the invention,

FIG. 4b: a side view of the section plane A-A through the example embodiment according to FIG. 4a,

FIG. 5: a perspective view of the example embodiment according to FIG. 1, with one half depicted without the housing, and

FIG. 6: a perspective view of an enlarged section of an example embodiment of a coin lift according to the invention.

### DETAILED DESCRIPTION

In the figures, identical reference signs designate identical or equivalent elements or parts of a coin lift according to the invention.

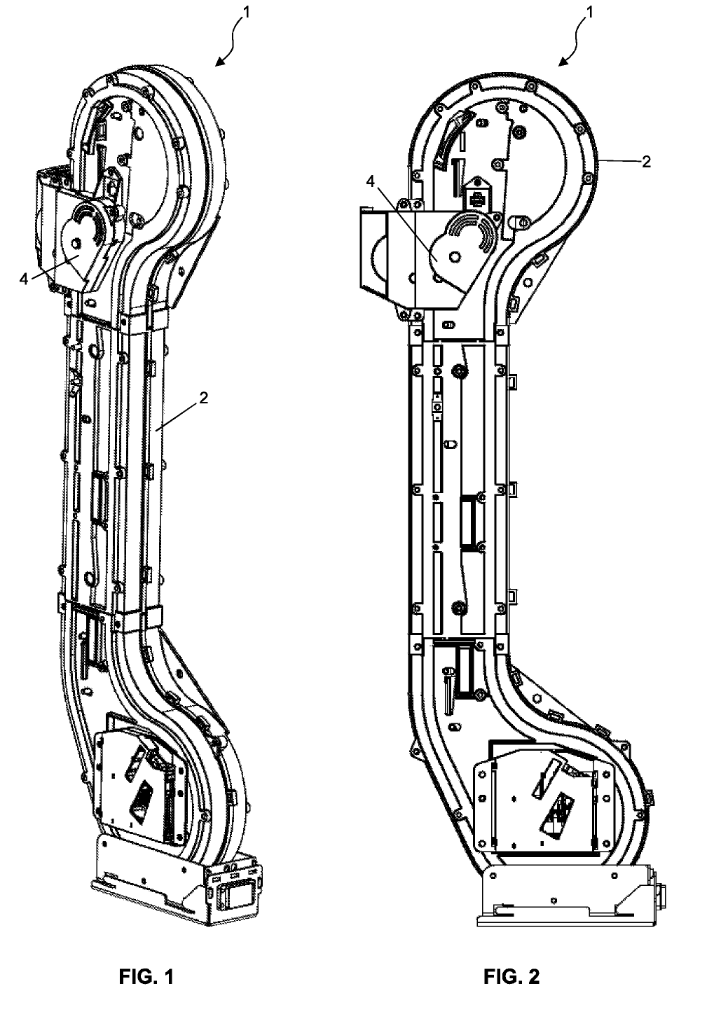

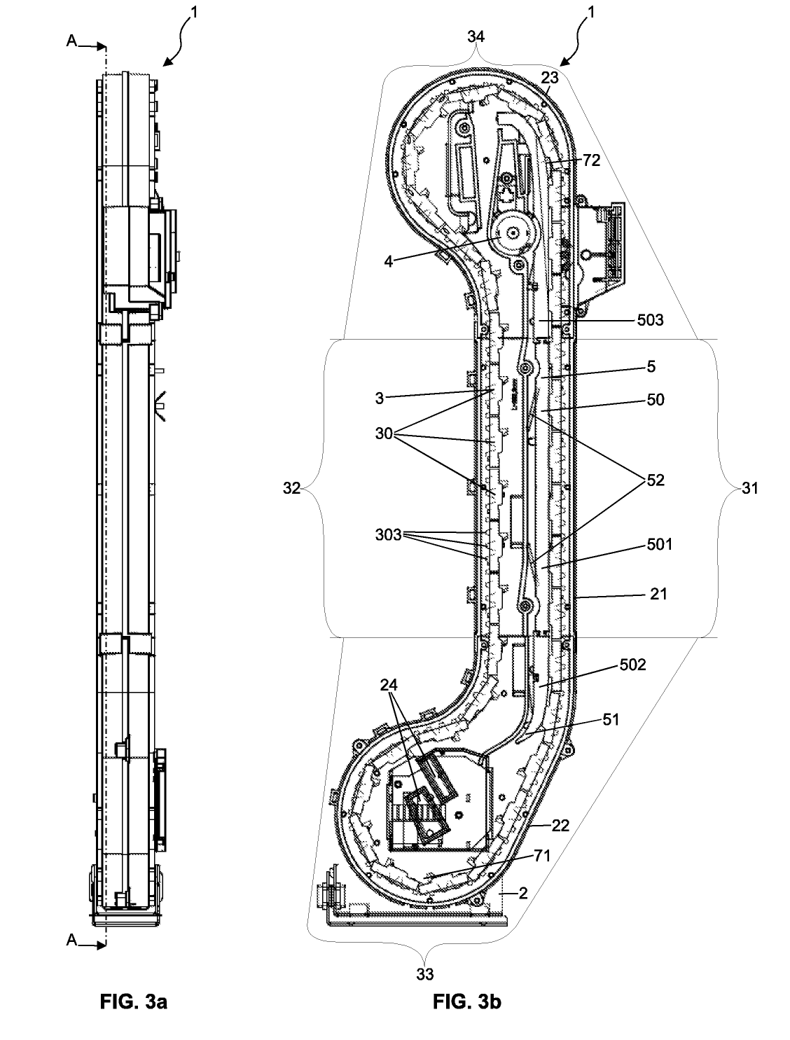

FIG. 1 shows a perspective view of a preferred example embodiment of a coin lift according to the invention. A side view of the example embodiment according to FIG. 1 is shown in FIG. 2, and a front view in FIG. 3a. FIG. 3b shows a side view of the section plane A-A, the position of which is represented in the front view according to FIG. 3a.

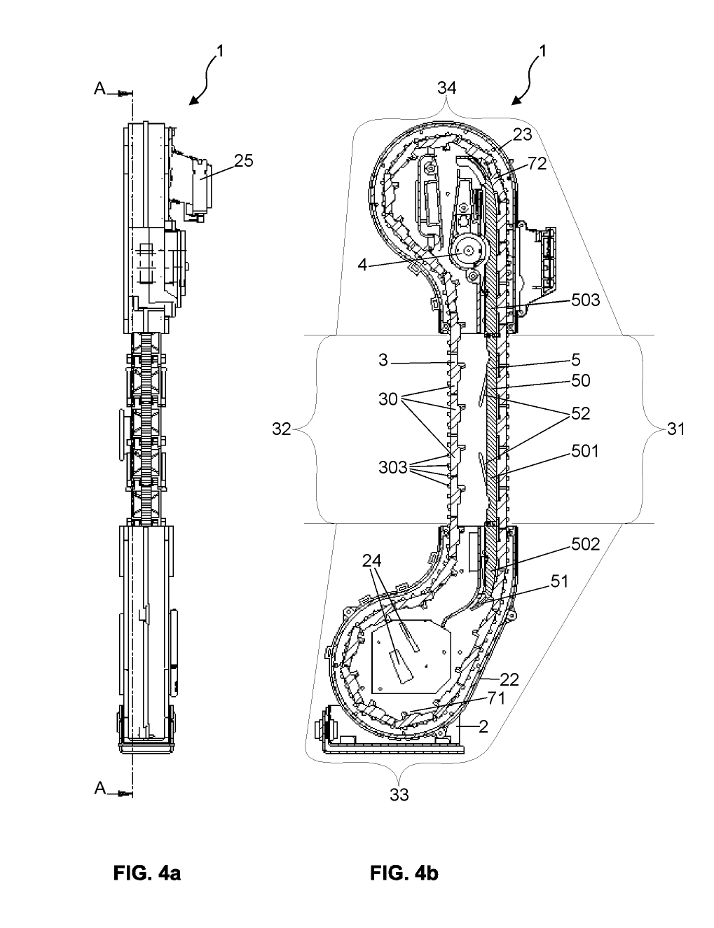

Another preferred example embodiment of a coin lift according to the invention is shown in FIGS. 4a and 4b, where the middle portion of housing 2 of coin lift 1 is not shown. Similar to FIGS. 3a and 3b, FIG. 4b shows a side view of the section plane A-A, the position of which is shown by the front view according to FIG. 4a. With the exception of one outlet channel 25, the example embodiment of FIGS. 4a and 4b corresponds to that of FIGS. 1, 2, 3a and 3b.

As can be seen in particular from FIGS. 3b and 4b, the conveyor loop 3 consists of a plurality of segments 30, which are connected to each other in an articulated manner about axes aligned transversely to the course of the conveyor loop 3, i.e. perpendicular to the drawing plane of FIGS. 3b and 4b, and which form an endless loop. Advantageously, the segments 30 can be separated from each other, preferably at the axes connecting them in an articulated manner. This allows the length of the conveyor loop 3 to be adjusted by removing or inserting one or more segments 30, for example for different overall heights of the coin lift 1. Alternatively, the conveyor loop can also consist of a single piece, for example in the form of a conveyor belt. When transporting coins and/or coin-like objects, the conveyor loop 3 runs in a vertically ascending direction in a first section 31, reverses its direction in a fourth section 34 into a vertically descending direction in a second section 32, only to return then to the vertically ascending direction of the first section 31 in a third section 33. The course of the conveyor loop 3 in the third section 33 and the fourth section 34 is preferably selected in such a way that the first section 31 and the second section 32 of the conveyor loop 3 run as closely side by side as possible in order to keep the volume occupied by the coin lift 1 as small as possible. For this purpose, both the third section 33 and the fourth section 34 each have an approximately s-shaped course at their ends adjacent to the second section 32. The conveyor loop 3 comprises an inner side, i.e. a surface on which the coins and/or coin-like objects are transported, and an outer side facing the housing 2. The segments 30 have a laterally projecting guide pin 301 on each of their two longitudinal sides. By means of these guide pins 301, the segments 30, and thus the entire conveyor loop 3, are each guided in one groove of the two opposite side walls of housing 2.

The housing 2 of the coin lift 1 has a second housing portion 22 enclosing the third portion 33 of the conveyor loop 3, a third housing portion 23 enclosing the fourth portion 34 of the conveyor loop 3, and a first housing portion 21 not shown in FIGS. 4a and 4b. The first housing portion 21 connects the second housing portion 22 separably or inseparably with the third housing portion 23. In the case of a separable connection, the coin lift 1 has a modular design, which allows the height of the coin lift 1 to be subsequently adjusted by replacing the old first housing portion 21 with a correspondingly long new first housing portion 21 and adjusting the length of the conveyor loop 3. The first housing portion 21 is preferably designed in such a way that it encloses the first section 31 and the second section 32 of the conveyor loop 3 as closely as possible, so that the volume occupied by the coin lift 1 is as small as possible.

A drive 4 for optionally driving the conveyor loop 3 is arranged in or on the third housing portion 23. Preferably, the drive 4 has an electric motor and a gearbox 41. If the electric motor can be controlled as required, a gearbox can be omitted. The conveyor loop 3 is advantageously driven by a gear wheel driven directly or indirectly by the electric motor, whose teeth engage in corresponding teeth 303 of the conveyor loop 3. The teeth 303 of the conveyor loop 3 are advantageously arranged on the outer side of the conveyor loop 3, i.e. on the side facing the housing 2, and not on the inner side, which is intended for transporting the coins and/or coin-like objects. Alternatively, if the conveyor loop is formed by a conveyor belt, the conveyor belt is driven by a pulley. Since the drive 4 is completely arranged in or on the third housing portion 23 and is thus maximally limited to the fourth section 34 of the conveyor loop 3, the first section 31 and the second section 32 of the conveyor loop 3 run outside the drive 4 and are therefore easily accessible for an adjustment of the overall height of the coin lift 1, which also promotes the modular design of the coin lift 1.

During its rotation, the conveyor loop 3 transports coins and/or coin-like objects from a first position 71 to a second position 72, which is higher than the first position 71. The first position 71 is formed by a collecting tray into which the coins and/or coin-like objects fall and/or slide by gravity after the coins and/or coin-like objects have been inserted into the coin lift 1 through one of the inlet slots 24. The conveyor loop 3 forms the bottom of the collecting tray 71. The second position 72 is a place of the conveyor loop 3, which is located next to an access opening of an outlet channel 25, through which the coins and/or coin-like objects leave the coin lift 1. Usually, the coins and/or coin-like objects are delivered by one or more hoppers, which are arranged laterally next to the coin lift 1. In addition to the inlet slots 24 arranged at the bottom in the second housing portion 22 for this delivery of the coins and/or coin-like objects by a hopper, the coin lift 1 may also have inlet slots arranged further up in the region of the first housing portion 21 and/or the third housing portion 23. These can be used, for example, for the entry of counterfeits that have been identified as such by a money checking device. The counterfeits fall and/or slide down the housing 2 until they also come to rest in the collecting tray 71. If there are coins and/or coin-like objects in the collecting tray 71 and the conveyor loop 3 is performing its rotary motion, each of the segments 30 takes only a single coin or coin-like object when passing through the collecting tray 71. For this purpose, each segment 30 has a lip 302 on its surface which is arranged approximately transversely to the transport direction. The height of the lip 302 perpendicular to the surface of segment 30 is dimensioned such that it is less than the combined thickness of two thinnest coins and/or coin-like objects lying one on top of the other, so that an upper coin or an upper coin-like object slips from a lower coin or a lower coin-like object and thus a separation of the coins and/or coin-like objects occurs as soon as the segment 30 is moved in an ascending direction and the lip 302 serves as a support edge for the (lower) coin or the (lower) coin-like object. For this purpose, the third section 33 of the conveyor loop 3 after the collecting tray 71, i.e. in FIGS. 3b and 4b to the right of the collecting tray 71, has an area, in which the conveyor loop 3 moves obliquely upwards, preferably at an angle of about 65° to the horizontal. Alternatively, if the conveyor loop is formed by a conveyor belt, the conveyor loop takes the coins and/or coin-like objects with it by utilising the static friction occurring between the surface of the conveyor loop and the coins and/or coin-like objects. The coins and/or coin-like objects are then also separated in the obliquely rising area of the conveyor loop right after the collecting tray, since the static friction between two coins and/or coin-like objects lying on top of each other is lower than the static friction between the transport belt and a coin or coin-like object.

The area of the conveyor loop 3 for separating the coins and/or coin-like objects is followed by an area of the conveyor loop 3 in which a press-on element 5 for pressing the coins and/or coin-like objects transported by the conveyor loop 3 onto the conveyor loop 3 is arranged parallel to the conveyor loop 3. The press-on element 5 has a strip element 50 which, when viewed in the direction of rotation of the conveyor loop 3, extends from a partial section at the end of the third section 33 over the entire first section 31 to a partial section at the beginning of the fourth section 34. Preferably, the strip element 50 is slightly bendable in its longitudinal direction, i.e. has limited bendability and is otherwise substantially rigid, for example as a moulded part made of plastic. The strip element 50 shown in FIGS. 3b and 4b is movably mounted in the housing 2 of the coin lift 1 at four points which are arranged at a distance from each other in the longitudinal direction of the strip element 50. Of these four bearing points of the strip element 50, only two are visible in FIGS. 3b and 4b, namely those in the area of the first section 31 of the conveyor loop 3. While in the areas of the two ends of the strip element 50 there is one further bearing point each, which is not visible in FIGS. 3b and 4b. Each of these bearing points has a spring element 52 which identifies the bearing points of the first section 31 in FIGS. 3b and 4b. The spring elements 52 preferably consist of two elastic plastic parts 521 and 522 each, which are arranged opposite each other on both longitudinal sides of the strip element 50 and are supported in receptacles in the housing 2, so that the strip element 50 presses on the surface of the conveyor loop 3. The receptacles for the spring elements 52, like the entire first housing portion 21, are not shown in FIG. 4b. It is advantageous for the elastic plastic parts 521 and 522 of a strip element 50 made of plastic to be cast onto the strip element 50. Alternatively, other spring elements known from the state of the art such as coil springs made of metal can also be used. Furthermore, the number and/or position of the bearing points can also vary in order to allow for the press-on element 5 to be positionable with as much variability as possible along its longitudinal axis with respect to its vertical distance to the surface of the conveyor loop 3 by utilising a combination of slight bending of the strip element 50 in its longitudinal direction and different deflections at the individual bearing points. The strip element 50 is preferably designed having three parts with a middle part 501 and two end parts 502 and 503, wherein the middle part 501 corresponds in its length and arrangement to the first section 31 of the conveyor loop 3, so that the press-on element 5 can also be adapted to a changed overall height of the coin lift 1 by replacing the middle part 501. The middle component 501 and the two end parts 502 and 503 can, for example, each be joined by a detachable snap connection and/or plug connection. To facilitate the insertion of coins and/or coin-like objects between the press-on element 5 and the conveyor loop 3, the press-on element 5 or the end part 502 has a curved and/or rounded end 51.

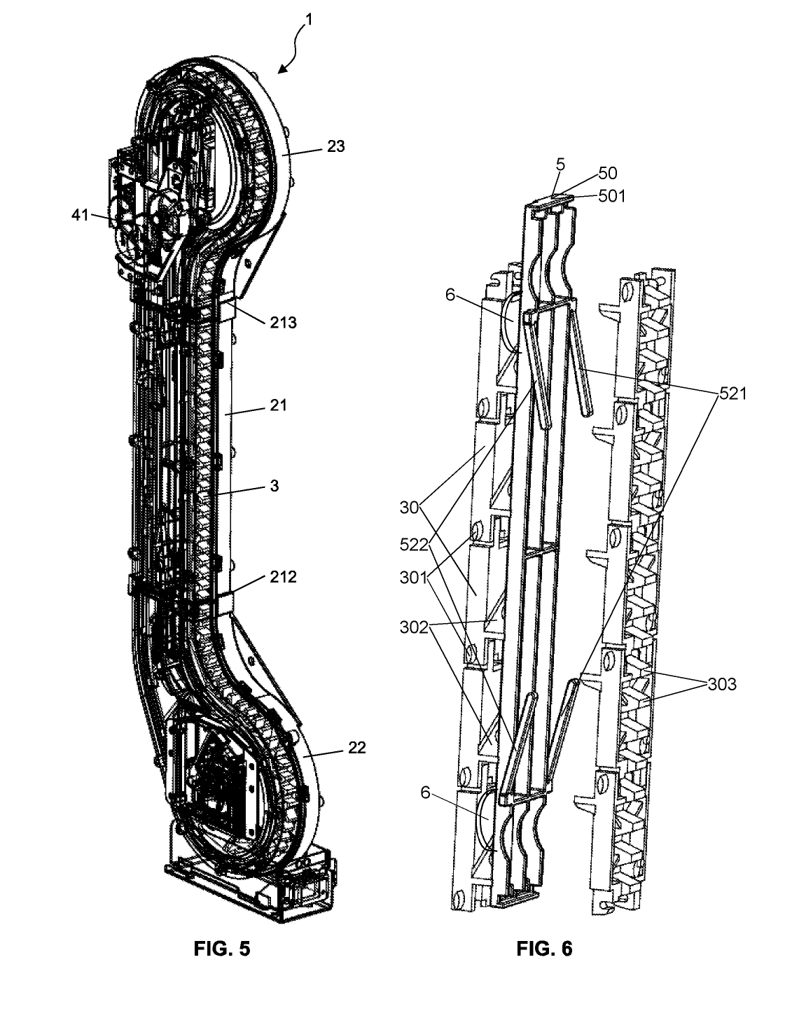

FIG. 5 shows a perspective view of the example embodiment according to FIG. 1, wherein FIG. 5 does not show the left half of the housing 2 of the coin lift 1. FIG. 5 shows in particular the gearbox 41 of the drive 4 as well as the connection 212 of the first housing portion 21 with the second housing portion 22 and the connection 213 of the first housing portion 21 with the third housing portion 23. The connections 212 and 213 preferably have snap connections and/or plug connections.

FIG. 6 shows a partial section of the coin lift 1 according to FIG. 1 in the area of the first section 31 and the second section 32 of the conveyor loop 3 in an enlarged perspective view. FIG. 6 shows in particular how the coins 6 and/or coin-like objects 6 stand on the lips 302 and are pressed by the press-on element 5 against the respective segment 30 of the conveyor loop 3. FIG. 6 also clearly shows how the two spring elements 52 on the middle part 501 of the strip element 50 are structured, namely each consisting of two elastic plastic parts 521 and 522, which are each arranged on the two opposite longitudinal sides of the strip element 50. Thus each of the bearing points of the strip element 50 and consequently of the press-on element 5 has in each case a spring element 52 consisting of two elastic plastic parts 521 and 522, each of the elastic plastic parts 521 and 522 being arranged in a respective receptacle in the housing 2 and being supported in the receptacle, so that the spring elements 52 press the press-on element 5 against the surface of the conveyor loop 3.

1. A coin lift for transporting coins and/or coin-like objects, the coin lift comprising:
an endless conveyor loop for transporting coins and/or coin-like objects from a first position to a second position higher than the first position, wherein the conveyor loop extends in an ascending direction in a first section and in a descending direction in a second section,
a drive for selectively driving said conveyor loop in a rotary motion, and
a press-on element for pressing the coins and/or coin-like objects transported by the conveyor loop onto the conveyor loop.

2. The coin lift according to claim 1, wherein the conveyor loop in the first section extends in a vertically ascending direction and in the second section extends in a vertically descending direction.

3. The coin lift according to claim 1, wherein the press-on element extends substantially along the first section of the conveyor loop.

4. The coin lift according to claim 1, wherein the press-on element along the conveyor loop can assume different distances from the conveyor loop in a direction perpendicular to the conveyor loop.

5. The coin lift according to claim 1, wherein the coin lift further comprises a device for dissipating an electrostatic charge of the coins and/or coin-like objects.

6. The coin lift according to claim 1, wherein the coin lift further comprises a housing comprising a replaceable first housing portion in which the first section and the second section of the conveyor loop extend substantially side by side.

7. The coin lift according to claim 1, wherein the conveyor loop is formed from a plurality of articulated segments which are separably connected to one another.

8. The coin lift according to claim 1, wherein the conveyor loop extends in a third section from the descending direction of the second section to the ascending direction of the first section and in a fourth section from the ascending direction of the first section to the descending direction of the second section.

9. The coin lift according to claims 6 and 8, wherein the housing further comprises a second housing portion and a third housing portion, wherein the third section of the conveyor loop extends in the second housing portion and the fourth section of the conveyor loop extends in the third housing portion.

10. The coin lift according to claim 9, wherein the first housing portion separably connects the second housing portion with the third housing portion.

11. The coin lift according to claim 8, wherein the conveyor loop in the third section or the fourth section is driven by the drive.

12. The coin lift according to claim 7, wherein the conveyor loop comprises lips through which a groove extends along the conveyor loop, and that a crest or web of the press-on element is insertable into the groove.
